(19) United States
(12) Patent Application Publication
(10) Pub. No.: US 2025/0305958 A1
(43) Pub. Date: Oct. 2, 2025

(54) MODULE TO INTEGRATE SINGLE CELL AUTOFLUORESCENCE LIFETIMES WITH SINGLE-CELL TRANSCRIPTION (SCRNA-SEQ)

(71) Applicant: Wisconsin Alumni Research Foundation, Madison, WI (US)

(72) Inventors: Melissa Skala, Middleton, WI (US); Kayvan Samimi, Madison, WI (US); Darcie Moore, Middleton, WI (US)

(21) Appl. No.: 18/624,849

(22) Filed: Apr. 2, 2024

(51) Int. Cl. G01N 21/64; B01L 3/00; G01J 3/44; G01N 15/10; G01N 15/14

(52) U.S. Cl. CPC G01N 21/6486; B01L 3/502784; G01J 3/4406; G01N 15/10; B01L 2200/0652; B01L 2300/0864; B01L 2400/0487; G01N 2015/1006; G01N 2015/1481

(57) ABSTRACT

Disclosed is a system for integrating single cell autofluorescence data with single cell assay data. The system includes a microfluidic chip including a sample inlet for introducing a cell sample, a sample channel including an observation zone, and a single cell autofluorescence spectrometer. The system further includes a removable cell container capable of collecting droplets each containing a single cell exiting the microfluidic chip and further capable of being subjected to a single cell assay. A processor and computer memory receive the autofluorescence data set and associate the autofluorescence data set with single cell assay data.

### STATEMENT REGARDING FEDERALLY SPONSORED RESEARCH

This invention was made with government support under R56NS130450 awarded by the National Institutes of Health. The government has certain rights in the invention.

### CROSS-REFERENCE TO RELATED APPLICATIONS

Not applicable.

### FIELD OF THE INVENTION

The disclosed technology is generally directed to cell autofluorescence. More particularly the technology is directed to correlating cell autofluorescence data with single-cell RNA sequencing data.

### BACKGROUND

Single-cell RNA sequencing (scRNA-seq) technology is a state-of-the-art approach for investigating RNA within individual cells or nuclei. scRNA-seq provides a tremendous amount of information regarding the transcriptome composition of cells. While cells from an organism may have the same set of genetic material, the transcriptome information in each cell at any given point in time reflects the unique activity of only a subset of gene. Traditional transcriptome from bulk tissue samples reveals bulk information and cannot be used to understand differences between individual cells. In comparison, scRNA-seq allows transcriptome activity to be combined with the cell identity, state, function and response and thus can provide detailed insights into cellular processes.

scRNA-seq is dependent on single-cell isolation. One important aspect of the cell isolation process is that each cell should be intact, homeostatic, and otherwise unaffected by the process. Some methods of cell isolation have been shown to induce the expression of stress genes, which complicates understanding of the transcription patterns. For a better understanding of cellular processes using scRNA-seq, there is a need for a system and/or a method of physically isolating single cells without affecting their state. More specifically, what is needed is a way to quickly and accurately correlate cell status and transcription or other assay data on a cell-by-cell basis.

### SUMMARY

A system for integrating single cell autofluorescence data with single cell assay data, the system including: a microfluidic chip including a sample inlet for introducing a cell sample, wherein the sample inlet is fluidly connected to a sample outlet by a sample channel, wherein the sample channel includes an observation zone downstream of the sample inlet; at least one pump and at least one flow regulator, wherein the at least one pump and the at least one flow regulator are coupled to the sample channel, wherein the flow regulator controls a flow velocity of the cell sample in the sample channel; a single cell autofluorescence detector including a photon source and a photon detector, wherein the photon source and the photon detector are positioned adjacent the observation zone, and wherein the single cell autofluorescence detector collects autofluorescence data from single cells within the observation zone; a removable cell container positioned adjacent the sample outlet; wherein a specific location of the removable cell container is aligned with the sample outlet, and wherein a droplet including a single cell exiting the sample outlet is deposited at the specific location in the removable cell container; and a processor and a non-transitory computer-readable medium having stored thereon instructions that, when executed by the processor, cause the processor to: a) receive the autofluorescence data set, wherein the autofluorescence data set includes at least one metabolic endpoint, and b) associate the autofluorescence data set with cell location data, wherein the cell location data includes the specific location in the removable cell container.

A method of preparing an indexed container for single cell autofluorescence-correlated assay, the method including: a) receiving a population of cells in a cell solution, b) flowing the cell solution at a flow velocity through a microfluidic chip including an observation zone, c) collecting single cell autofluorescence data for a cell as the cell solution flows through the observation zone, d) depositing the cell in a droplet at a first location in the indexed container, wherein the first location is stored in a non-transitory computer-readable medium, e) associating the single cell autofluorescence data with the first location, f) repeating steps c-e, wherein the subsequent cells are deposited at unique locations in the indexed container, g) subjecting the indexed container to a single cell assay to obtain single cell assay data for each cell, and h) associating the single cell assay data with the autofluorescence data via the location of the cell in the indexed container.

A cell assay cartridge including: a cell container including a plurality of compartments, wherein each of the compartments contains either an individual cell or zero cells, and a plurality of autofluorescence data sets, wherein each of the autofluorescence data sets corresponds to one of the individual cells and to one of the compartments, wherein the autofluorescence data is stored in a non-transitory computer-readable medium, and wherein the cell container is ready for single cell assay processing.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows (A) a block diagram of a system, (B) a microfluidic chip according to an aspect of the present disclosure, (C) a microfluidic chip according to another aspect of the present disclosure, and (D) a diagram of an embodiment of the system of (A), according to an aspect of the present disclosure.

FIG. 2 shows a diagram of a negative mold for a microfluidic chip, in accordance with an aspect of the present disclosure.

FIG. 3 is a diagram showing the timing of single-cell autofluorescence data collection as a cell flows through an observation zone, in accordance with an aspect of the present disclosure. More specifically, the diagram shows a custom photon stream time-correlated single photon counting (TCSPC) histogramming and cell transit event detection algorithm. (A) A timeline diagram showing the relative timing of the excitation sync pulse and the photon detection, where dt is the time of photon detection-time of excitation pulse. A time tagger device records dt, which is the photon detection time relative to the excitation laser sync pulse. Multiple dt values are recorded as a histogram in between clock pulses from a 1 ms external clock. The slow 1 ms clock keeps track of macro-time events such as transit of a single cell through the laser illumination spot. (B) The photon counts within the stream of 1 ms histograms are compared against the background count rate to produce a logical binary stream of cell detection decisions. If more than two consecutive 1 ms histograms have higher than background counts, these histograms are combined to produce the autofluorescence decay histogram assigned to a single cell transit event.

FIG. 4 is a flowchart illustrating a method, in accordance with an aspect of the present disclosure.

FIG. 5 shows (A) a schematic diagram of a autofluorescence lifetime flow cytometer, in accordance with an aspect of the present disclosure. The system includes a 375 nm picosecond-pulsed diode laser operated at 50 MHz pulse repetition rate, two ultra bialkali photon-counting PMTs, an FPGA-based time tagger connected to a computer via USB 3.0 connection, a CMOS camera with near-infrared illumination for bright field view of the flow cell. The microfluidic flow cell is made from PDMS bonded to No. 1 coverglass, and the sample cells are injected through the channel using a high-precision syringe pump. Autofluorescence decays from single cells are recorded. (B) The excitation laser beam at the focal plane has a Ø12 μm full width at half maximum Gaussian profile. Inset shows the CMOS view of the excitation beam illuminating a thin film of saturated coumarin-6 solution in ethanol. (C) The axial profile of the confocal volume has a measured 20 μm full width at half maximum using a Ø1 mm confocal iris.

FIG. 6 is a photograph of a multiwell plate where each well contains a droplet and at least one fluorescent bead as shown by a grey spot or a white spot within the droplet.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices and methods relating to modifying biological molecules are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, the term “FAD” refers to flavin adenine dinucleotide.

As used herein, the term “memory” includes a non-volatile medium, e.g., a magnetic media or hard disk, optical storage, or flash memory; a volatile medium, such as system memory, e.g., random access memory (RAM) such as DRAM, SRAM, EDO RAM, RAMBUS RAM, DR DRAM, etc.; or an installation medium, such as software media, e.g., a CD-ROM, or floppy disks, on which programs may be stored and/or data communications may be buffered. The term “memory” may also include other types of memory or combinations thereof.

As used herein, the term “NAD(P)H” refers to reduced nicotinamide adenine dinucleotide and/or reduced nicotinamide dinucleotide phosphate.

As used herein, the term “processor” may include one or more processors and memories and/or one or more programmable hardware elements. As used herein, the term “processor” is intended to include any of types of processors, CPUs, microcontrollers, digital signal processors, or other devices capable of executing software instructions.

As used herein, the term “redox ratio” or “optical redox ratio” refers to a ratio of NAD(P)H fluorescence intensity to FAD fluorescence intensity; a ratio of FAD fluorescence intensity to NAD(P)H fluorescence intensity; a ratio of NAD(P)H fluorescence intensity to any arithmetic combination including FAD fluorescence intensity; or a ratio of FAD fluorescence intensity to any arithmetic combination including NAD(P)H fluorescence intensity.

Autofluorescence endpoints include photon counts/intensity and fluorescence lifetimes. The fluorescence lifetime of cells can be a single value, the mean fluorescence lifetime, or compromised from the lifetime values of multiple subspecies with different lifetimes. In this case, multiple lifetimes and lifetime component amplitude values are extracted. Both NAD(P)H and FAD can exist in quenched (short lifetime) and unquenched (long lifetime) configurations; therefore, the fluorescence decays of NAD(P)H and FAD are fit to two components. Generally, NADH and FAD fluorescence lifetime decays are fit to a two component exponential decay, I(t)=α₁e^{-t/τ1}+α₂e^{-t/τ2}+C, where I(t) is the fluorescence intensity as a function of time, t, after the laser pulse, α₁ and α₂ are the fractional contributions of the short and long lifetime components, respectively (i.e., α₁+α₂=1), τ₁ and τ₂ are the short and long lifetime components, respectively, and C accounts for background light. However, the lifetime decay can be fit to more components (in theory any number of components, although practically up to ˜5-6) which would allow quantification of additional lifetimes and component amplitudes. By convention lifetimes and amplitudes are numbered from short to long, but this could be reversed. A mean lifetime can be computed from the lifetime components, (τₘ=α₁τ₁+α₂τ₂ . . . ). Fluorescence lifetimes and lifetime component amplitudes can also be approximated from frequency domain data and gated cameras/detectors. For gated detection, a₁ could be approximated by dividing the detected intensity at early time bins by later time bins. Alternatively, fluorescence anisotropy can be measured by polarization-sensitive detection of the autofluorescence, thus identifying free NAD(P)H as the short rotational diffusion time in the range of 100-700 ps.

NAD(P)H α₁ refers to the contribution of free NAD(P)H and is the shortest lifetime that is not dominated (i.e., greater than 50%) by instrument response and/or scattering. NAD(P)H α₁ is the contribution associated with NAD(P)H lifetime values from 200-1500 ns, from 200-1000 ns, or from 200-600 ns. For clarity, a claim herein including features related to a “shortest” lifetime cannot be avoided by defining the lifetime values to include a sacrificial shortest lifetime that is dominated by instrument response and/or scattering.

Metabolic endpoints that can be obtained from the autofluorescence data include the NAD(P)H shortest lifetime amplitude component or NAD(P)H α₁. The metabolic endpoints can also optionally include one or more of the following: NAD(P)H fluorescence intensity; FAD fluorescence intensity; an optical redox ratio (i.e., a combination of NAD(P)H and FAD intensities such as NAD(P)H/FAD or FAD/NAD(P)H or FAD/[NAD(P)H+FAD] or NAD(P)H/[NAD(P)H+FAD], see definition above); NAD(P)H second shortest lifetime amplitude component or NADPH α₂; NAD(P)H third shortest lifetime amplitude component or NADPH α₃; NAD(P)H mean fluorescence lifetime or NAD(P)H τₘ; NAD(P)H first fluorescence lifetime or NAD(P)H τ₁; NAD(P)H second fluorescence lifetime or NAD(P)H τ₂; NAD(P)H third fluorescence lifetime or NAD(P)H τ₃; NAD(P)H fourth fluorescence lifetime or NAD(P)H τ₄; NAD(P)H fifth fluorescence lifetime or NAD(P)H τ₅; FAD first amplitude component or FAD α₁; FAD second shortest lifetime amplitude component or FAD α₂; FAD third shortest lifetime amplitude component or FAD α₃; FAD mean fluorescence lifetime or FAD τₘ; FAD first fluorescence lifetime or FAD τ₁; FAD second fluorescence lifetime or FAD τ₂; FAD third fluorescence lifetime or FAD τ₃; FAD fourth fluorescence lifetime or FAD τ₄; and FAD fifth fluorescence lifetime or FAD τ₅.

The various aspects may be described herein in terms of various functional components and processing steps. It should be appreciated that such components and steps may be realized by any number of hardware components configured to perform the specified functions.

### Systems

This disclosure provides systems. The systems can be suitable for use with the methods described herein. When a feature of the present disclosure is described with respect to a given system, that feature is also expressly contemplated as being combinable with the other systems and methods described herein, unless the context clearly dictates otherwise.

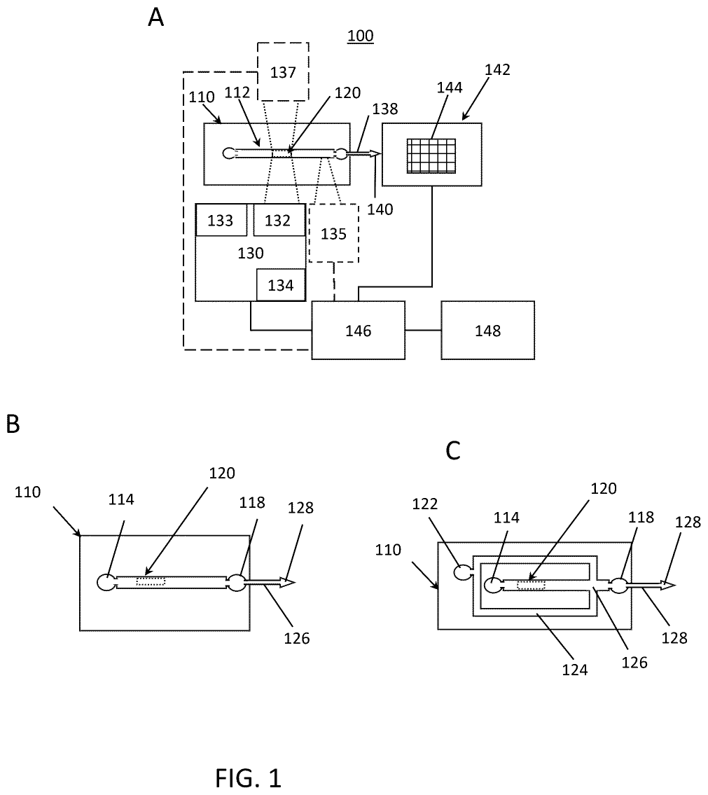

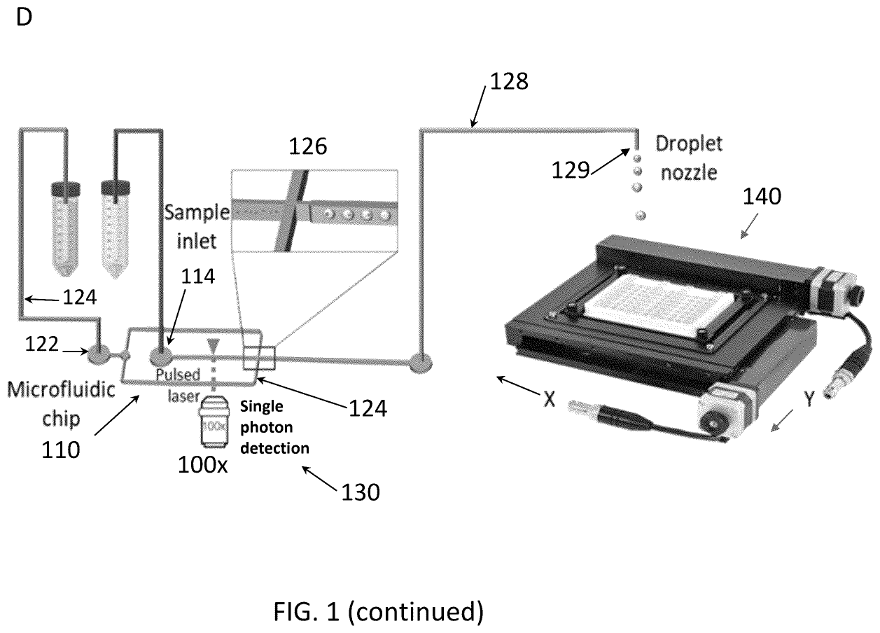

Referring to FIG. 1A, the present disclosure provides a system 100. The system 100 includes a microfluidic chip 110, a sample pathway 112, an observation zone 120, a single-cell autofluorescence spectrometer 130, and a cell collector 140. The system 100 includes a processor 146 and a non-transitory computer-readable medium 148, such as a memory.

The microfluidic chip 110 can be made from any material suitable for etching or molding microchannels that are connected together in order to mix, pump, separate, or control the sample fluids. For example, the microfluidic chip 110 can be formed from glass, silicon, or a polymeric material. In some aspects, the microfluidic chip 110 can be a molded material. In other aspects, the microfluidic chip 110 can additively manufactured. In particular aspects, the microfluidic chip 110 can be molded polydimethylsiloxane (PDMS). The microfluidic chip 110 can be disposable.

At least one transparent surface can be included in the microfluidic chip 110 to allow investigation of the autofluorescence properties of the sample. According to an aspect, the microfluidic chip 110 can be formed from materials with high optical clarity and low fluorescence. According to another aspect, the microfluidic chip 110 can include a molded material bonded or fixed to a transparent material. In a particular aspect the transparent material can be a glass pane, for example, a no. 1 coverslip. The transparent portion can have a thickness of between about 50 μm and about 500 μm.

The microfluidic chip 110 includes at least a portion of the sample pathway 112. FIG. 1 B shows the microfluidic chip 110 in greater detail. The sample pathway 112 includes a sample inlet 114, a sample channel 116, and a sample outlet 118. The sample outlet 118 is fluidly coupled to the sample inlet 114 via the sample channel 116. The sample inlet 114 can be any nanofluidic, microfluidic, or other fluidic inlet. A person having ordinary skill in the art of fluidics has knowledge of suitable inlets 114 and outlets 118, and the present disclosure is not intended to be bound by one specific implementation of the sample inlet 114 or sample outlet 118.

A sample can be introduced into the microfluidic chip 110 via the sample inlet 114. A sample reservoir (not shown) can be used to supply the sample to the microfluidic chip 110. The sample can be a liquid medium containing a suspension of cells or other particulate analytes. In some aspects, it may be useful to agitate the sample reservoir to prevent settling of the sample. Agitation of the sample can be achieved, for example, using a magnetic device, a rocker, a shaker, or an agitator. At least one pump and/or at least one flow regulator (not shown) can control the flow of the sample through the microfluidic chip 110. In some aspects, the flow regulator can be a syringe pump. A person having ordinary skill in the art has knowledge of suitable agitators, pumps and flow regulators and the present disclosure is not intended to be bound by one specific implementation of pumps and/or flow regulators.

The at least one pump and/or flow regulator can control the flow velocity in the sample pathway 112. The flow velocity of the cell sample can be between about 0.1 mm/s and about 10 mm/s, between about 0.3 mm/s and about 8 mm/s, between about 0.5 mm/s and about 5 mm/s, between about 1 mm/s and about 4 mm/s. The flow velocity can be about 2 mm/s.

The cross-sectional dimensions of the sample channel 116 can be selected according to the size of the largest analyte in the sample. Samples can include a single type of analyte or a mixture of analytes. While the system 100 can be used for single cells, it is contemplated that analytes can optionally include particles, groups of cells, viral particles, or bacterial cells. Suitably, the width dimension and height dimension of at least one zone of the sample channel 116 can be selected to accommodate passage of analytes or individual cells in single file. The sample channel 116 can have a cross-sectional area of between about 25 μm² and about 20,000 μm². In some aspects, the width dimension of the sample channel 116 can be 5 μm, 10 μm, 25 μm, 50 μm, 100 μm, or 200 μm. In other aspects, the height dimension of the sample channel 116 can be 5 μm, 10 μm, 25 μm, 50 μm, 100 μm, or 200 μm. Additionally, and alternatively, the sample channel 116 can have regions with different cross-sectional areas.

The sample channel 116 in the observation zone 120 is configured to present individual cells for interrogation. In one aspect, the sample channel 116 is sized to allow cells to flow through the observation zone 120 in a single file arrangement. A person having ordinary skill in the art has knowledge of suitable observation zones 120 and the present disclosure is not intended to be bound by one specific implementation of an observation zone 120. The observation zone 120 is positioned upstream of the sample outlet 118.

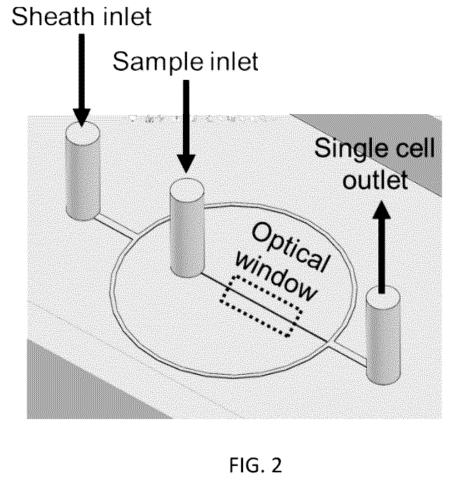

According to an implementation shown in FIG. 1 C, the microfluidic chip 110 can include a sheath inlet 122 fluidly coupled to a sheath channel 124. Another implementation of the sheath channel is shown in FIG. 2, which shows a negative mold for the microfluidic chip 110. In FIG. 2, the sheath channel 124 is shown as having a circular shape, while having a rectangular shape in FIG. 1C. A person having ordinary skill in the art of fluidics has knowledge of suitable sheath fluid configurations, and the present disclosure is not intended to be bound by one specific implementation of the sheath channel 124.

The sheath fluid can be an aqueous solution of components for supporting cells in a desired state, for example homeostasis, quiescence, or an activation state. In an aspect, the sheath fluid is a cell medium. In another aspect, the sheath fluid is a buffer. In yet another aspect, the sheath fluid can be oil-based. In a further aspect, the sheath fluid has approximately the same components as the cell sample. The sheath fluid can be supplied from a sheath fluid reservoir (not shown) and introduced into the microfluidic chip 110 at the sheath inlet 122. The sheath channel 124 joins the sample channel 116 at an intersection 126 downstream of the observation zone 120. The sample outlet 118 is downstream of the intersection 126.

The sheath channel 124 can have a cross-sectional area of between about 5,000 μm² and about 20,000 μm². At least one pump and/or flow regulator electronically coupled to the processor 146 can be used to control the flow of the sheath fluid. The volumetric flow rate of the sheath fluid can be between about 1 μL/min to 100 μL/min. The volumetric sheath fluid flow rate along with nozzle diameter determines the droplet formation frequency at the outlet nozzle. In one example, the sheath fluid has a volumetric flow rate of 80 μL/min which results in the formation of about one droplet per second, where the droplets have a volume of 1-2 μL. The volumetric sheath fluid flow rate and the nozzle diameter can be varied to produce droplets of volume less than 1 μL, for example, the volume can be less than 0.9 μL, less than 0.5 μL, or less than 0.1 μL. In some examples, the droplet volume can be about 100 nL, about 50 nL, or about 10 nL.

As shown in FIG. 1A, the microfluidic chip 110 can include a deposition pathway 128 extending from the sample outlet 118. The deposition pathway 128 is fluidly coupled to the sample outlet 118 and conducts the sample away from the microfluidic chip 110. The deposition pathway 128 has a length sufficient to extend from the intersection to the cell collector 140. According to an aspect, the deposition pathway 128 can include a length of tubing. In a particular aspect, the tubing can have a 250 μm diameter. The terminal end of the deposition pathway 128 can be fitted with a nozzle 129. The nozzle 129 directs the sample as it exits the deposition pathway 128. In an aspect, the nozzle 129 can be a 34 Ga needle having a 50 μm inner diameter and a 150 μm outer diameter. It is contemplated that the nozzle 129 can have a diameter between about 10 μm and about 100 μm. One example of the arrangement of components of system 100 is shown in FIG. 1 D.

The cell collector 140 can include a moveable stage 142 coupled to a removeable cell container 144. The removeable cell container 144 can be fixed on the moveable stage 142 during use and released from the moveable stage 142 when not in use. The position of the moveable stage 142 can be controlled by the processor 146. The moveable stage 142 is configured to be precisely and quickly repositioned, for example by the use of servo motors. In particular, the moveable stage can move in the x-y plane as shown in FIG. 1 D. A person having ordinary skill in the art has knowledge of suitable moveable stages 142, and the present disclosure is not intended to be bound by one specific implementation of the moveable stages 142. In an aspect, the processor 146 can send instructions to the moveable stage 142 to align a specific location within the removable cell container 144 with the nozzle 129.

The cell container 144 can have a plurality of compartments or wells. In an aspect, the cell container is a commercially available multiwell plate. In some aspects, the cell container 144 can have 96 wells, 384 wells, or 1536 wells.

The relative position of the nozzle and the cell container 144 is arranged as follows. The cell container 144 is positioned on the moveable stage 142, and the first compartment (i.e., first location for cell deposition) is positioned directly in line with the nozzle. The relative position of the cell container 144 with respect to the nozzle can be adjusted manually by a user to an initial position. Additionally, and alternatively, the position of the cell container 144 can be adjusted according to instructions sent electronically from the processor to the moveable stage 142 to move to the desired initial position. The initial position serves as a reference, or “zero” position. This reference position is recorded by the processor. In cases where the cell container 144 is a multiwell plate, the processor includes data regarding the dimensions of the plate and the dimensions of the wells. Using this data, the processor can instruct the moveable stage 142 to move from the reference position to a new position such that the nozzle is aligned with any desired well in the plate. The processor can be programmed to move between compartments in any desired pattern including but not limited to, a serpentine pattern, row-by-row, column-by-column, or any pattern suitable for the deposition of cells. The processor can record and store data regarding which well or compartment is positioned below the nozzle at any given time, how far the motorized stage has traveled from the reference position, and which wells have already received a cell.

The cell container 144 can be subjected to an assay. In an aspect, the assay can be a nucleic acid sequencing assay. In a particular aspect, the assay can be single cell RNA sequencing. In another aspect, the assay can be selection for desired single cell function such as colony forming, drug resistance, stem cell behavior, or self-renewing capacity. In another aspect, the assay can be a proteomics assay. In a still further aspect, the assay can be a mass spectrometric assay.

According to an aspect, the cell container 144 can be part of a cell assay cartridge 150. The cell assay cartridge can include the cell container 144 and the non-transitory computer-readable medium 148. The cell assay cartridge can include the cell container 144 and a connection to the data stored on the non-transitory computer-readable medium 148. Additionally, and alternatively, the cell container 144 can include wells containing assay reagents. The cell assay cartridge 150 can be used with system 100 to collect single cells, autofluorescence data for each single cell, and assay data for each single cell, such that the autofluorescence data and the assay data can be correlated.

The autofluorescence spectrometer 130 includes a light source 132, a photon-counting detector 133, and photon-counting electronics 134. The single-cell autofluorescence detector 133 is arranged adjacent the observation zone 120. The sample channel 116 includes at least one transparent portion to provide the observation zone 120 with an optical window for observation, interrogation, excitation (e.g., laser illumination) and fluorescence emission detection. The single-cell autofluorescence detector 133 and the observation zone 120 are arranged such that photons emanating from cells within the observation zone 120 can impinge on the single-cell autofluorescence detector 133.

The single-cell autofluorescence detector 133 can be any detector suitable for measuring single-cell autofluorescence as understood by those having ordinary skill in the optical arts. Examples of suitable single-cell autofluorescence detectors 133 include, but are not limited to, a photomultiplier tube, a camera, a photodiode, an avalanche photodiode, a streak camera, a charge capture device, and the like.

The single-cell autofluorescence detector 133 can be directly (i.e., the processor 146 communicates directly with the detector 133 and receives the signals) or indirectly (i.e., the processor 146 communicates with a sub-controller that is specific to the detector 133 and the signals from the detector 133 can be modified or unmodified before sending to the processor 146) controlled by the processor 146. Fluorescence lifetime information can be obtained using time-domain (time-correlated single-photon counting, gated detection) or frequency-domain methods. The system 100 can include various optical filters tuned to isolate autofluorescence signals of interest. The optical filters can be tuned to the autofluorescence wavelengths of NAD(P)H and/or FAD.

The autofluorescence spectrometer 130 can optionally include a light source 132 for optically exciting the analyte cells to initiate autofluorescence. Suitable light sources 132 include, but are not limited to, lasers, LEDs, lamps, filtered light, fiber lasers, and the like. The light source 132 can be pulsed, which includes sources that are naturally pulsed and continuous sources that are chopped or otherwise optically modulated with an external component.

The light source 132 can provide pulses of light having a full-width at half maximum (FWHM) pulse width that is of a duration that is adequate to achieve the spectroscopic goals described herein, as would be appreciated by one having ordinary skill in the spectroscopic arts. In some cases, the FWHM pulse width is at least 1 fs, at least 5 fs, at least 10 fs, at least 25 fs, at least 50 fs, at least 100 fs, at least 200 fs, at least 350 fs, at least 500 fs, at least 750 fs, at least 1 ps, at least 3 ps, at least 5 ps, at least 10 ps, at least 20 ps, at least 50 ps, or at least 100 ps. In some cases, the FWHM pulse width is at most 10 ns, at most 1 ns, at most 900 ps, at most 750 ps, at most 600 ps, at most 500 ps, at most 400 ps, at most 250 ps, at most 175 ps, at most 100 ps, at most 75 ps, at most 60 ps, at most 50 ps, at most 35 ps, at most 25 ps, at most 20 ps, at most 15 ps, at most 10 ps, or at most 1 ps.

The light source 132 can emit wavelengths that are tuned to the absorption of NAD(P)H and/or FAD. In some cases, the wavelength is at least 340 nm, at least 345 nm, at least 350 nm, at least 355 nm, at least 360 nm, at least 365 nm, or at least 370 nm. In some cases, the wavelength is at most 415 nm, at most 410 nm, at most 405 nm, at most 400 nm, at most 395 nm, at most 390 nm, at most 385 nm, or at most 380 nm. In some cases, the wavelength is between 360 nm and 415 nm, between 350 nm and 410 nm, or between 370 nm and 380 nm. In some cases, the wavelength is 375 nm. In some cases, the wavelength is 2 times or 3 times these wavelength values (i.e., the frequency is ½ or ⅓). It should be appreciated that pulsed light sources inherently have some degree of bandwidth, so they are never exactly monochromatic. Thus, references herein to “wavelength” refer to either a wavelength at the peak intensity or a weighted average wavelength. In some cases, the pulsed light source 424 is a UV pulsed diode laser. In some cases, the pulsed light source has a wavelength that is double the peak absorption wavelength of NAD(P)H and/or FAD, with an ultrashort pulse duration, such that fluorescence excitation is achieved through two-photon excitation events, as understood by those having ordinary skill in the optical arts.

The photon-counting detector 133 can be any detector suitably capable of detecting single photons and delivering an analog or digital output representative of the detected photons. Examples of photon-counting detectors 133 include, but are not limited to, a photomultiplier tube, a photodiode, an avalanche photodiode, a single-photon avalanche diode (SPAD), a charge-coupled device, combinations thereof, and the like.

The photon-counting electronics 134 can include electronics understood by those having ordinary skill in the art to be suitable for use with single-photon detectors 133 to produce the data sets described herein. Examples of suitable photon-counting electronics 134 include, but are not limited to, a field-programmable gate array (FPGA), a dedicated digital signal processor (DSP) with a digitizer and a time-to-digital converter, a time-correlated single photon counting (TCSPC) electronic board with time-to-amplitude and analog-to-digital converter electronics (as implemented by Becker & Hickl, Berlin, Germany), combinations thereof, and the like.

The single-cell autofluorescence detector 133 can be configured to acquire the autofluorescence data set at a repetition rate of between 1 kHz and 20 GHz. In some cases, the repetition rate can be between 1 MHz and 1 GHz. In other cases, the repetition rate can be between 20 MHz and 100 MHz. The light source 132 can be configured to operate at these repetition rates.

The autofluorescence spectrometer 130 can be directly (i.e., the processor 146 communicates directly with the spectrometer 130 and receives the signals) or indirectly (i.e., the processor 146 communicates with a sub-controller that is specific to the spectrometer 130 and the signals from the spectrometer 130 can be modified or unmodified before sending to the processor 146) controlled by the processor 146. Autofluorescence data sets can be acquired by known spectroscopic methods. Fluorescence lifetime images can also be acquired by known imaging methods and those acquired images can be used by the systems and methods described herein, as would be understood by those having ordinary skill in the spectroscopic arts. The system 100 can include various optical filters tuned to isolate autofluorescence signals of interest. The optical filters can be tuned to the autofluorescence wavelengths of NAD(P)H and/or FAD.

The autofluorescence spectrometer 130 can be configured to acquire the autofluorescence dataset from the electrical output of detector 133 at a repetition rate understood by those having ordinary skill in the spectroscopic arts to be suitable for providing adequate sampling to observe the dynamics disclosed herein. In some cases, the repetition rate can be at least 1 kHz, at least 5 kHz, at least 10 kHz, at least 30 kHz, at least 50 kHz, at least 100 kHz, at least 500 kHz, at least 750 kHz, at least 1 MHZ, at least 4 MHZ, at least 7 MHz, at least 10 MHZ, at least 15 MHz, at least 20 MHz, at least 50 MHz, at least 100 MHz, at least 500 MHz, or at least 1 GHz. In some cases, the repetition rate can be at most 1 THz, at most 800 GHz, at most 500 GHz, at most 250 GHz, at most 150 GHz, at most 100 GHz, at most 70 GHz, at most 50 GHz, at most 25 GHz, at most 15 GHZ, at most 10 GHz, at most 6 GHZ, at most 2 GHz, at most 1 GHz, at most 750 MHZ, at most 500 MHZ, at most 400 MHZ, at most 250 MHz, at most 175 MHz, or at most 100 MHz. While there can be downside associated with oversampling, in principle the present disclosure can function with as high of a sampling rate as can be achieved with existing technology. The repetition rates identified herein are based on the state of the art at the time the present disclosure was prepared and filed and are not intended to be limiting in the event that future developments facilitate a greater repetition rate.

The pulsed light source 132 can be configured to operate at pulse repetition rates that are adapted to acquire the needed fluorescence lifetime information. The maximum pulse repetition rate is limited by the fluorescence lifetime of the fluorophore of interest. The fluorescence decay must have fully died down by the time the next pulse of light is introduced to the sample in order to avoid ambiguity about the sources of data sets (i.e., to avoid uncertainty about whether a particular fluorescent photon was initiated by the most recent excitation pulse of light or the one preceding it). The pulsed light source 132 can have a pulse repetition rate of up to 100 MHz, up to 80 MHZ, up to 60 MHz, or up to 40 MHz. The lower limit of the pulse repetition rate is more practical in a sense of reducing the overall sampling time, but theoretically the data can be taken more slowly if there is some reason to do so.

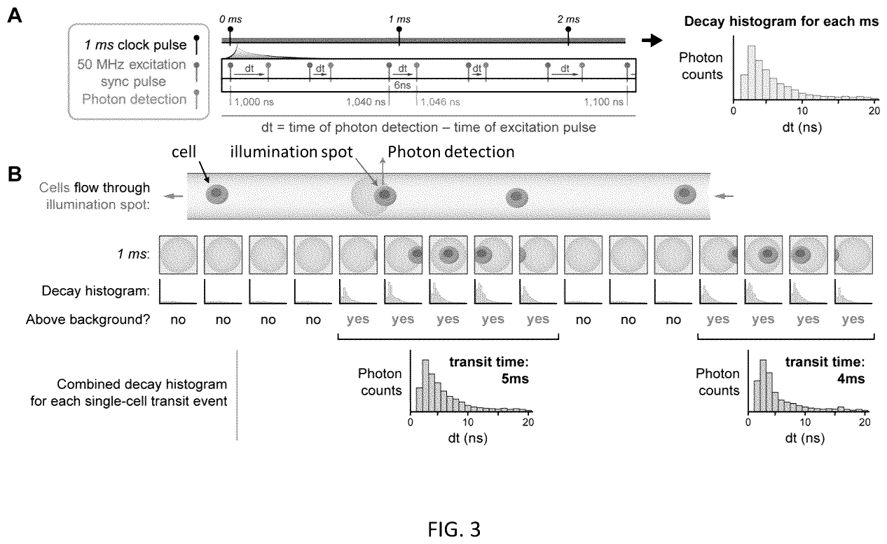

The timing of the flow of samples and autofluorescence data collection are shown in FIGS. 3A and 3B. The light source 132 creates an illumination spot within the observation zone 120. The cells flow through the illumination spot as shown in FIG. 3B. The time it takes for a cell to flow through the illuminated spot is a cell transit time. The cell transit time can be, for example 10 ms, 9 ms, 8 ms, 7 ms, 6 ms, 5 ms, 4 ms, 3 ms, 2 ms, or 1 ms.

Macro-time events can be timed using an external clock, for example 1 ms timeframes can be determined using a 1 ms clock pulse. In some aspects, the timeframes can be any length of time between 0.1 ms and 5 ms. For example, the timeframes can be 0.1 ms, 0.5 ms, 1 ms, 2 ms, 3 ms, 4 ms, or 5 ms. The relative timing of the millisecond clock, the autofluorescence excitation pulse, and the photon detection times are shown in FIG. 3A. These timeframes can correspond to an interrogation time or the photon collection time.

The photon counting electronics 134 (e.g., FPGA-based time taggers) are programmed to detect cell transit events, when a cell passes through the illuminated spot as shown in FIG. 3B. The photon counting electronics 134 can store separate autofluorescence decay data sets (histograms) for each cell transit event. More specifically, the time tagger device can record dt, which is the photon detection time relative to the excitation laser sync pulse. Multiple dt values are recorded as a histogram within the timeframe set by the millisecond clock pulses. The count of photons detected within 1 ms timeframes are compared against the background count rate. If the histograms from more than two consecutive 1 ms timeframes have higher than background counts, these histograms are combined to produce the autofluorescence decay histogram assigned to a single cell transit event.

The system 100 can optionally include a cell size measurement tool 135. The cell size measurement tool 135 can be any device capable of measuring the size of cells, including but not limited to, an optical microscope. In some cases, the single-cell autofluorescence detector 133 and the cell size measurement tool 135 can be integrated into a single optical subsystem. The system 100 can optionally include an optical microscope 137 for acquiring visual images of cells that are located in the observation zone 120 or elsewhere along the sample pathway 112.

The processor 146 is in electronic communication with the single-cell autofluorescence detector 133. The processor 146 is in electronic communication with the at least one pump and/or at least one flow regulator of the microfluidic chip 110. The processor 146 is also in electronic communication with, when present, the optional light source 132 and the optional cell size measurement tool 135.

The non-transitory computer-readable medium 148 has stored thereon instructions that, when executed by the processor 146, cause the processor 146 to execute at least a portion of the methods described herein. The non-transitory computer-readable medium 148 can be local to the system 100 or can be remote from the system 100, so long as it is accessible by the processor 146. The non-transitory computer-readable medium 148 can be mobile or transferrable. For example, the non-transitory computer-readable medium 148 can be physically or virtually associated with the microfluidic chip 110.

The system 100 can be described as a single-photon excited lifetime-sensitive flow cytometer that acquires whole-cell TCSPC NAD(P)H fluorescence decays from single cells in a microfluidic flow channel. In some examples, the system 100 can acquire single cell fluorescence decay data at rates up to 100 cells per second. This flow geometry is attractive for interrogating multiple biological questions including immune cell activation, stem cell differentiation, optimization of cell therapy manufacturing, rapid drug screening, and other situations in which touch-free metabolic assessment of cells is desirable. Importantly, as labeled flow-based analyses are common in many fields, this tool provides seamless integration into existing operational procedures without the need for additional training or deep understanding of new fluorescence lifetime microscopy (FLIM) instrumentation or concepts.

From an instrumentation perspective, this fluorescence lifetime flow cytometer has simplified optics, a smaller footprint, and uses lower-cost single-photon excitation lasers compared to multiphoton FLIM, while maintaining high accuracy in fluorescence decay measurements and high sensitivity to cell function. The picosecond-pulsed UV diode laser in our system costs significantly less than a femtosecond-pulsed Ti:Sapphire laser, power supply, water chiller, polarization optics, and Pockels cell needed for a two photon FLIM system. The flow geometry of the microfluidic chip as disclosed herein removes the need for scanning optics (scan lens, galvanometer mirrors, and electronics). As such, the flow system has an area footprint over 5× smaller than a two photon FLIM system.

### Methods

This disclosure provides a variety of methods. It should be appreciated that various methods are suitable for use with other methods. Similarly, it should be appreciated that various methods are suitable for use with the systems described elsewhere herein. When a feature of the present disclosure is described with respect to a given method, that feature is also expressly contemplated as being useful for the other methods and systems described herein, unless the context clearly dictates otherwise.

The system 100 and methods disclosed herein provide one-to-one correspondence between cell fluorescence lifetimes and cellular assays to relate cell function and biochemical profiles. For example, cell fluorescence lifetimes and single cell sequencing can relate cell function, status, and transcription. Basic science studies can be performed to relate cell function and transcription on a single cell level to understand cell heterogeneity in biological processes.

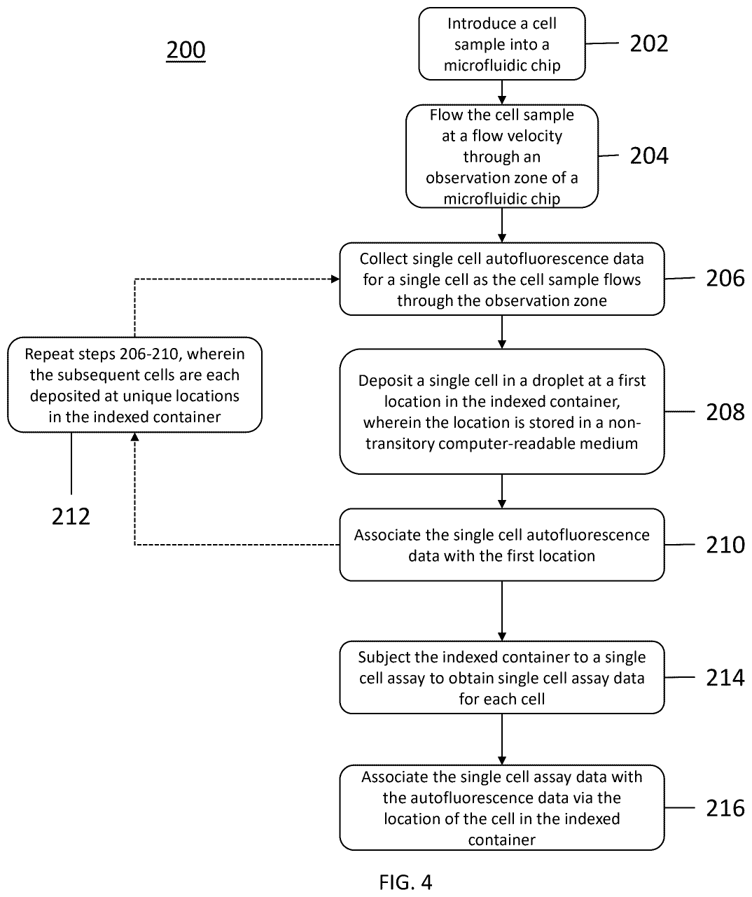

Disclosed herein is a method 200, as shown in FIG. 4. According to the method 200 as disclosed herein, at 202, a cell sample can be introduced into the system 100 via the sample inlet 114. At 204, the cell sample can be flowed through the sample pathway 112 at a cell flow rate. At 206, the cell sample flows through the observation zone 120, an autofluorescence data set is collected for a single cell and written to a computer memory. The cell spends sufficient time in the observation zone in order for sufficient autofluorescence data to be collected. The amount of time the cell spends in the observation zone is determined by the flow velocity. In other words, flow velocity is the independent variable that determines the interrogation time (i.e., photon collection time) per cell. The interrogation time can be between about 0.1 ms and about 100 ms. In some aspects, the interrogation time can be between 1 ms and 10 ms. In particular aspects, the interrogation time can be 1 ms.

The sample channel flow rate is the product of sample channel cross-sectional area and the sample flow velocity. In an aspect, the sample channel flow rate can be between about 0.1 μL/min and about 1 μL/min. In another aspect, the sample channel flow rate can be between about 0.1 μL/min and about 0.5 μL/min. In a particular aspect, the sample channel flow rate can be about 0.3 μL/min.

Sheath fluid can be introduced in the sheath inlet 122 and flowed through the sheath channel 124 at a sheath flow rate. The sheath flow rate can be between about 10 μL/min and about 500 μL/min. In another aspect, the sample channel flow rate can be between about 50 μL/min and about 100 μL/min. In a particular aspect, the sample channel flow rate can be about 80 μL/min.

At the intersection 126, the sheath fluid and cell sample combine and continue along the deposition pathway 128 at a deposition path flow rate. The deposition path flow rate is the sum of the sheath flow rate and the sample flow rate. The cell sample exits the deposition pathway 128 in droplets that are deposited at specific locations in the cell container 144.

The cell sample flows next to the intersection 126 where the sheath fluid combines with the cell sample to form a cell solution. The cell solution exits the sample outlet 118 and flows along the deposition pathway at a deposition flow rate.

At 208, the single cell is deposited in a droplet at a specified unique location in the cell container 144. The droplet volume is determined by the nozzle diameter and deposition flow rate. In an aspect, the droplets can have a volume between about 100 nL and 2 μL. In a particular aspect, the droplets can be between about 1 μL and 1.5 μL. The droplet deposition rate can be between about 1 droplet per second and 10 droplets per second. In an aspect, the deposition rate is one 1.3 μL droplet per second or about 80 μL/min.

The cell container 144 is an indexed container. In other words, the cell container 144 has multiple locations within the boundaries of the container that are designated for single cell deposition. The cell container is indexed such that all possible unique locations are listed in the computer memory. The processor 146 controls the flow rates and the movement of the stage 142. The deposition flow rate allows a single cell per droplet to be deposited at a unique, specific location in the indexed container.

At 210, the unique location of the single cell is recorded and associated with the single cell autofluorescence data for that single cell. The location of each single cell is stored in the non-transitory computer-readable medium where the autofluorescence data sets for each single cell are also associated with the single cell locations.

The concentration of cells in the cell sample determines the cell number flow rate, or the rate at which single cells can be deposited. The cell number flow rate can correspond to the droplet deposition rate. In an aspect, 0.2 million cells per 1 mL corresponds to one cell per droplet per second. The cell sample can be diluted to reduce the chance of multiple cells per single droplet. Dilution of the cell sample can increase the number of droplets having no cells at the outlet.

At 212, the steps 206-210 are repeated to deposit a desired number of cells. The desired number of cells deposited can be any number between 1 cell and 5 million cells. In some examples, the number of cells deposited is between 100 cells and 500,000 cells, between 500 cells and 10,000 cells, or between 2,000 cells and 5,000 cells. In some examples the number of cells deposited is about 3000 cells.

At 214, the cell container 144 is subjected to a single cell assay. As discussed previously, the assay can be any kind of single-cell assay, including but not limited to a nucleic acid sequencing assay, single cell RNA sequencing, an assay for proteins, lipids, or metabolites.

At 216, the assay data is associated with the autofluorescence data via each unique location in the indexed container. The single cell assay provides biochemical data for each single cell which is associated with the autofluorescence data in the computer memory via the unique cell locations.

Autofluorescence lifetimes can be biomarkers for disease states that are associated with metabolic dysfunction, including cancer, autoimmune diseases, cardiovascular diseases, and diabetes. Importantly, autofluorescence lifetime measurements provide insight into molecular interactions and cellular metabolism without the use of exogenous reagents. As such, the systems and methods as disclosed herein can be readily applied to study novel biological and biopharmaceutical questions, without the upfront need to develop cell-specific labels and markers that can be costly, labor-intensive, have poor reproducibility, or are prohibited in some applications (e.g., T cell or stem cell therapies in patients), while yielding valuable metabolic information. Combining this metabolic information with biochemical assay information, such as single-cell sequencing or other assays can provide valuable insight into cellular processes.

The system 100 as described herein allows for label-free, non-destructive, longitudinally repeatable measurements with real-time analysis in a flow geometry that is amenable to preclinical, clinical, and cell manufacturing settings that require automation, higher-throughput, and unaltered cell state. A continuous readout of cell metabolic state based on autofluorescence lifetimes may provide more insight into cell function than a binary readout based on surface markers, for example.

The system and methods disclosed herein enable single cell deposition to provide one to one correspondence between cell fluorescence lifetimes and single cell sequencing to relate cell function and transcription. The system as disclosed herein allows single-cell autofluorescence lifetime measurements to be used a standard assay for state-of-the-art biomedical research. For example, neural stem cells can be analyzed using the system and method, and the scRNA-seq data can be used to confirm that autofluorescence lifetimes robustly identify neural stem cell trajectory from quiescence to activation. This new technology will also provide insight into the heterogeneity in neural stem cell activation on the single cell level, with broad potential for application to understand single cell function across other model systems. Thus, by leveraging the power of this new platform to link autofluorescence imaging and live cellular dynamics to the single cell transcriptome, cell metabolism, behavior, identity, and underlying molecular mechanisms can be connected at a single cell resolution, filling a large gap in the field of stem cell research.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1

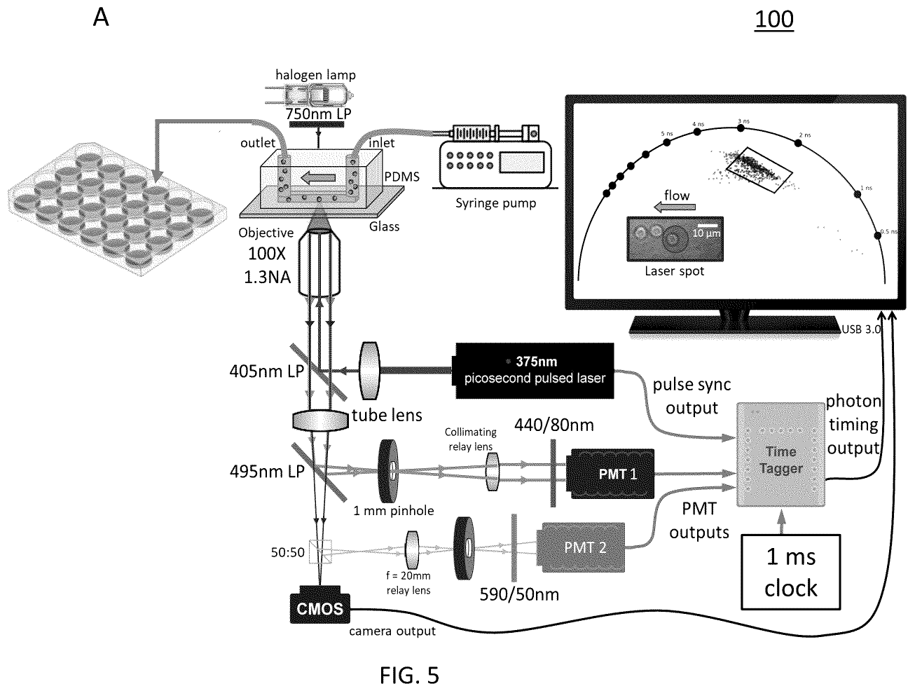

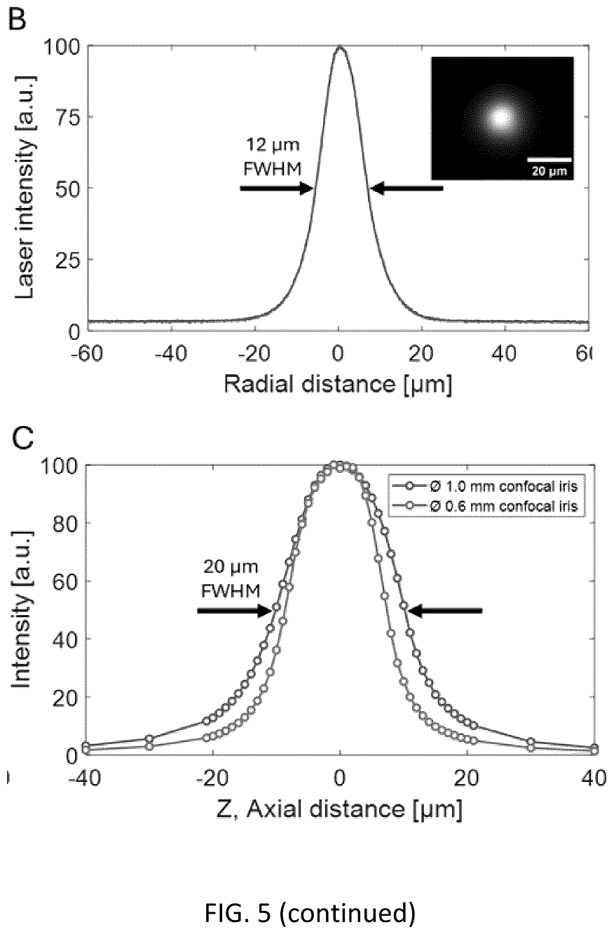

A schematic diagram of an exemplary system as a high-throughput autofluorescence flow instrument is shown in FIG. 5A. The instrument includes a microfluidic chip having a sample inlet connected to a sample reservoir, a sheath fluid inlet connected to a sheath fluid reservoir. The sheath fluid serves to dilute the cells such that each droplet contains one cell. The instrument further includes an autofluorescence detector including a pulsed laser with single photon detection. The cells flow through an illumination spot from the pulsed laser so the cell autofluorescence data can be collected. Additionally, a motorized stage collects the droplets containing single cells in a multiwell plate.

As shown in FIG. 5A, a lifetime-sensitive microfluidic flow cytometer with two color channels was built around an inverted Ti-S microscope (Nikon Instruments Inc., Melville, NY) equipped with a motorized PZ-2000 stage (Applied Scientific Instrumentation, Eugene, OR). For autofluorescence excitation, the inventors used a QuixX 375-70PS picosecond-pulsed diode laser (Omicron-Laserage Laserprodukte GmbH, Rodgau, Germany) operated at 50 MHz pulse repetition rate (i.e., 20 ns interval) and producing narrow (<90 ps width) pulses. The 375 nm laser beam (Ø1 mm 1/e²) was coupled through the epi-illumination port, tube lens (f=165 mm), 405 nm long-pass (LP) dichroic mirror, and a 100×1.3 NA oil-immersion objective lens (Nikon) to produce a Ø12 μm full width at half maximum (FWHM) Gaussian profile at the focal plane (FIG. 5 B) with an average power of 0.6 mW. This spot size was chosen to closely match the size of a single cell and minimize background excitation to produce optimal signal to background ratio. For the beads experiment a neutral-density (ND) filter with optical density of 3 was used to lower the excitation laser power.

NAD(P)H autofluorescence emissions were collected by the same objective lens and detected using an ultra bialkali H10721P-210 PMT (Hamamatsu Corp., Bridgewater, NJ) placed on a side port after a 495 nm LP dichroic mirror, a Ø1 mm confocal iris, and a 440/80 nm emission filter (Semrock Inc., Rochester, NY). A second PMT collected longer wavelength (590/50 nm) signal from autofluorescence or exogenous labels when applicable. The confocal iris had a back-projected diameter of 10 μm at the sample focal plane, which matches the lateral size of the illumination spot and single cells. The corresponding axial profile of the confocal volume had a measured 20 μm FWHM (FIG. 5 C).

Time-resolved measurement of the autofluorescence emissions was achieved by time-correlated single photon counting (TCSPC). A field programmable gate array (FPGA)-based time tagger device, Time Tagger Ultra (Swabian Instruments GmbH, Stuttgart, Germany) was used to measure the time difference between an excitation laser pulse and the detection of an autofluorescence photon by a PMT. These photon time tags were continuously transferred via USB 3.0 to a host computer that compiled them into autofluorescence decay histograms over many cycles of the excitation laser. An external function generator supplied a 1 kHz clock signal that defined the collection period of successive histograms.

A acA1300-200 μm CMOS camera (Basler Inc., Exton, PA) with near-infrared illumination from the halogen lamp with 750 nm LP Schott glass filter (Thorlabs Inc., Newton, NJ) provided brightfield images of the flow cell to focus the optics and verify proper flow through the channel. This near-infrared illumination does not interfere with the autofluorescence spectrum of NAD(P)H.

The flow cells were made from polydimethylsiloxane (PDMS), SYLGARD 184 (Dow Inc., Midland, MI) for rapid prototyping. Negative molds of the microfluidic channel were designed in SolidWorks (Dassault Systèmes Corp., Paris, France) and fabricated using a resin 3D printer, Viper SI2 (3D Systems Inc., Rock Hill, SC). PDMS was cured in the 3D-printed molds at 90° C. for 30 minutes. Next, it was demolded, plasma cleaned (PDC-001, Harrick Plasma Inc., Ithaca, NY), and bonded to No. 1 cover glass that formed the bottom surface of the channel and the optical window for the 100× objective lens. A biopsy punch to the top of the PDMS channel provided openings for inlet and outlet tubing connections. Samples were injected through the inlet using a 100 μL glass syringe (Hamilton Company, Reno, NV) and a syringe pump (Pump 11 Elite, Harvard Apparatus, Holliston, MA).

A custom TCSPC algorithm was programmed in Python using the Time Tagger application programming interface (API) to compile autofluorescence decay histograms from the stream of photon detection time tags and detect cell transit events from transient increases in photon count rate (FIG. 3). The program reads all time tags from the Time Tagger device over USB 3.0 every 10 ms and generates decay histograms in between 1 ms clock pulses from the external function generator. The 1 ms period corresponds to 50,000 excitation pulses from the 50 MHz laser source. Each histogram records the distribution of time differences (dt) between PMT photon detection time tags and their preceding excitation laser sync pulse (FIG. 3A). The 1 ms histogramming period is small enough that each cell transit event (with a nominal 5 ms transit duration) results in about 5 consecutive histograms with significant autofluorescence photon counts. As such, the program constantly compares the photon counts of the 1 ms histograms against the background photon count rate. The background photon count rate threshold is estimated as the median value of the 1 ms histogram photon counts over the last 5 seconds, given the low duty cycle of a cell transit event (typically 1% to 10% depending on sample concentration) over any given 5 seconds. A logical binary stream of cell detection decisions is generated by this threshold over background (FIG. 3B). If more than two consecutive histograms have higher than a user-defined multiple (typically 1.5×) of this threshold for background photon counts, a cell transit event is identified, and these histograms are combined to produce and record the associated autofluorescence decay histogram.

Phasor representation of the data as shown in FIG. 5A is a computationally low-cost and fast way to reduce each single cell decay histogram to a single point on a two-dimensional phasor plot that provides contrast between different fluorescence lifetimes. Briefly, the phasors are the complex coefficients of the Fourier series expansion of the time-resolved decay at harmonics of the laser repetition frequency. Therefore, the first harmonic phasor was calculated and plotted in real time for each cell as a (G, S) Cartesian coordinate pair according to:

G(ω)=Σₜ₌₁^{Nbins} I(t)·cos(ωt)/Σₜ₌₁^{Nbins}I(t) and S=Σₜ₌₁^{Nbins}I(t)·sin(ωt)/Σₜ₌₁^{Nbins}I(t),

where ω=2πnf is the frequency of phasor calculation with f being the laser repetition frequency (50 MHz here) and n being the harmonic number (one here).

Phasor analysis has the linearity property, such that a combination of two fluorescent molecular species gives rise to a linear combination in the phasor space, with the combined phasor falling on the straight line connecting the phasors of the individual constituting species. Deconvolution of the impulse (or the instrument) response function (IRF) in the phasor space amounts to a scale and rotation transformation of the raw phasor coordinates. The magnitude and phase of this transformation was estimated from the raw phasor of the time-resolved IRF curve, which was measured from a specular reflection of the excitation laser spot by a retroreflector mirror, and had a 350 ps FWHM.

### Example 2

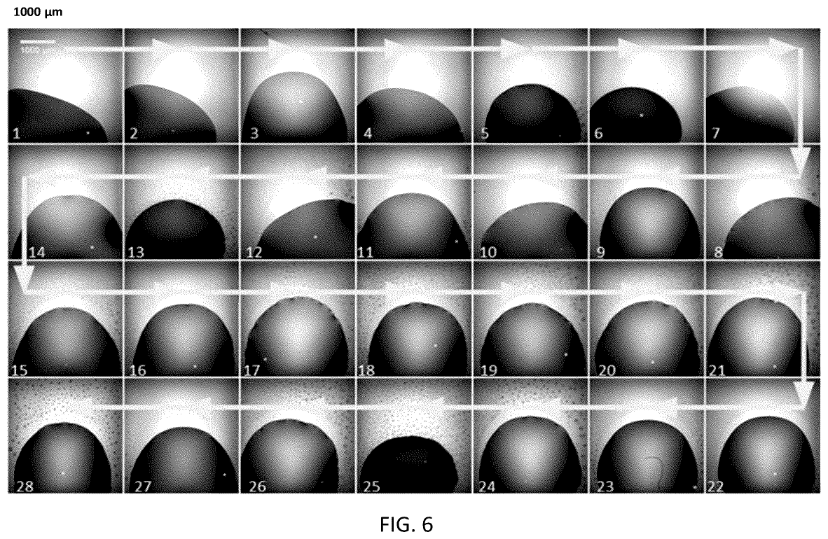

Fluorescent beads were first used as a known standard to test the fluorescence lifetime flow cytometer. For this experiment, a flow channel with both horizontal and vertical focusing sheath inlets, producing a 25-μm core was used. FIG. 6 shows a photograph of a multiwell plate where each well contains a droplet deposited by the exemplary lifetime-sensitive microfluidic flow cytometer. Within each droplet is at least one fluorescent bead. Wells 2, 4, 5, 7, 8, 9, 10, 13, 15, 24, 25 contain a single pink fluorescent bead (white spots in FIG. 6) while wells 1, 3, 6, 11, 12, 14, 16, 17, 18, 19, 20, 21, 23, 27, 28 contain a single green fluorescent bead (gray spots). Well 22 contains one pink bead (white spot) and one green bead (gray spot).

### Example 3

### Calculation of Delay Between Measurement and Deposition

There is a fixed delay between optical measurement and droplet deposition due to the length of the pathway. This delay can be determined in a calibration step where the volume of the tubing and the volume of the droplets is determined. Dividing the volume of the tubing by the volume of a single droplet gives the delay in terms of the number of droplets that pass through the deposition pathway before the droplet containing the optically measured cell is deposited.

### Calculation of Target Flow Velocity

The flow velocity determines the transit time of the cells through the Ø12 μm laser illumination spot. Given an empirical autofluorescence photon count rate of 2 million photons per second observed from T cells with the system set up as described in Example 1, and a target photon count of 10,000 photons per cell for accurate two-component lifetime estimation, a target integration time of 5 ms per cell was calculated. Therefore, a flow velocity of 2.4 mm/s (i.e., 12 μm/5 ms) or slower can be calculated as a target flow velocity.

### Calculation of Light Dose

The ultraviolet light dose from the 0.6 mW laser beam onto T cells crossing a Ø12 μm illumination spot in 5 ms is calculated as follows:

$$Light dose = Irradiance \times Transit time = \frac{{P}_{a v g}}{A} \cdot T = \frac{6 \times 1 {0}^{- 4} W}{1.13 \times 1 {0}^{- 6} {cm}^{2}} \cdot 5 \times 1 {0}^{- 3} s = 2.65 J {cm}^{- 2}$$

The calculated light dose is about 10× below the viable light dose for T cells at this wavelength.

We claim:

1. A system for integrating single cell autofluorescence data with single cell assay data, the system comprising:
a microfluidic chip comprising a sample inlet for introducing a cell sample, wherein the sample inlet is fluidly connected to a sample outlet by a sample channel, wherein the sample channel includes an observation zone downstream of the sample inlet;
at least one pump and at least one flow regulator, wherein the at least one pump and the at least one flow regulator are coupled to the sample channel, wherein the flow regulator controls a flow velocity of the cell sample in the sample channel;
a single cell autofluorescence detector comprising a photon source and a photon detector, wherein the photon source and the photon detector are positioned adjacent the observation zone, and wherein the single cell autofluorescence detector collects autofluorescence data from single cells within the observation zone;
a removable cell container positioned adjacent the sample outlet;
wherein a specific location of the removable cell container is aligned with the sample outlet, and
wherein a droplet comprising a single cell exiting the sample outlet is deposited at the specific location in the removable cell container; and
a processor and a non-transitory computer-readable medium having stored thereon instructions that, when executed by the processor, cause the processor to:
a) receive the autofluorescence data set, wherein the autofluorescence data set comprises at least one metabolic endpoint, and
b) associate the autofluorescence data set with cell location data, wherein the cell location data comprises the specific location in the removable cell container.

2. The system of claim 1, wherein the flow velocity is between about 0.1 mm/s and about 10 mm/s.

3. The system of claim 1, wherein the droplet is between about 100 nL and about 2 μL in volume.

4. The system of claim 1, wherein the single cell assay includes at least one single cell sequencing assay.

5. The system of claim 1, wherein the single cell assay is selected from the group consisting of a single cell mass spectrometric assay, colony forming function, drug resistance function, stem cell behavior, self-renewing capacity, or any combination thereof.

6. The system of claim 1, wherein the single cell autofluorescence detector is configured to acquire the autofluorescence data set via time-correlated single photon counting.

7. The system of claim 1, wherein the single cell autofluorescence detector is a photomultiplier tube or a photodiode.

8. The system of claim 1, wherein the at least one metabolic endpoint further includes an endpoint selected from the group consisting of optical redox ratio, NAD(P)H mean fluorescence lifetime (τₘ), NAD(P)H first fluorescence lifetime component (τ₁), NAD(P)H second fluorescence lifetime component (τ₂), flavin adenine dinucleotide (FAD) τₘ, FAD α₁, FAD τ₁, FAD τ₂, and combinations thereof.

9. The system of claim 1, wherein the non-transitory computer-readable medium having stored thereon further instructions that, when executed by the processor, further cause the processor to:
c) receive single cell assay data sets, and
d) associate the single cell assay data set with the autofluorescence data set and with cell location data.

10. The system of claim 1, wherein the microfluidic chip is disposable.

11. The system of claim 1, wherein the removable cell container is a multiwell plate.

12. The system of claim 2, wherein the flow velocity is based on a cell size and an interrogation time required by the autofluorescence detector between about 0.1 ms and about 100 ms.

13. The system of claim 1, wherein the microfluidic chip further comprises:
a sheath inlet fluidly connected to a sheath fluid channel, wherein the sheath fluid channel fluidly connects the sheath inlet to the sample channel at an intersection, wherein the intersection is downstream of the observation zone.

14. The system of claim 1, further comprising a moveable stage coupled to the removeable cell container, wherein the moveable stage is configured to move the removeable cell container to align the specific location of the removable cell container with the sample outlet.

15. A method of preparing an indexed container for single cell autofluorescence-correlated assay, the method comprising:
a) receiving a population of cells in a cell solution,
b) flowing the cell solution at a flow velocity through a microfluidic chip comprising an observation zone,
c) collecting single cell autofluorescence data for a cell as the cell solution flows through the observation zone,
d) depositing the cell in a droplet at a first location in the indexed container, wherein the first location is stored in a non-transitory computer-readable medium,
e) associating the single cell autofluorescence data with the first location,
f) repeating steps c-e, wherein the subsequent cells are deposited at unique locations in the indexed container,
g) subjecting the indexed container to a single cell assay to obtain single cell assay data for each cell, and
h) associating the single cell assay data with the autofluorescence data via the location of the cell in the indexed container.

16. The method of claim 15, wherein the droplets are between about 1 μL and 3 μL.

17. The method of claim 15, wherein a sheath fluid is combined with the cell solution downstream of the observation zone.

18. The method of claim 15, wherein the flow velocity is determined by a cell size and an interrogation time of the cell.

19. A cell assay cartridge comprising:
a cell container comprising a plurality of compartments, wherein each of the compartments contains either an individual cell or zero cells, and
a plurality of autofluorescence data sets,
wherein each of the autofluorescence data sets corresponds to one of the individual cells and to one of the compartments,
wherein the autofluorescence data is stored in a non-transitory computer-readable medium, and
wherein the cell container is ready for single cell assay processing.

20. The cell assay cartridge of claim 19, wherein the plurality of compartments further contains assay reagents.

21. The cell assay cartridge of claim 19, wherein the cell container is subjected to single cell assay processing.

22. The cell assay cartridge of claim 21, wherein the single cell assay provides a single cell transcription data set for each of the cells in the cell container, wherein each single cell transcription data set is correlated to the autofluorescence data set obtained for the individual cell.
